(19) United States
(12) Patent Application Publication
(10) Pub. No.: US 2015/0014612 A1
(43) Pub. Date: Jan. 15, 2015

(54) Pry Bar Having Improved in Structural Strength and Greater Support Area

(71) Applicant: Mou-Tang Liou, Taichung City (TW)

(72) Inventor: Mou-Tang Liou, Taichung City (TW)

(21) Appl. No.: 13/940,467

(22) Filed: Jul. 12, 2013

(51) Int. Cl. B25C 11/00; B25D 1/04

(52) U.S. Cl. CPC B25C 11/00; B25D 1/04
USPC 254/26 R; 254/25

(57) ABSTRACT

A pry bar includes a body and a claw disposed at a first end of the body. The claw includes a rib and wing structure. The rib and wing structures are both extended away from the body in a first direction. The rib and wing structures are disposed at front and back sides of the claw respectively, with the front side opposite the back side. The rib and wing structures each have a width extended in a second direction transverse to the first direction, with the width of the rib structure different from that of the wing structure. The rib structure reinforces structural strength of the claw and the wing structure provides the claw with a greater support area to contact with a surface with which an objected to be pried is engaged.

### BACKGROUND OF THE INVENTION

1. Field of the Invention

The present invention relates to a pry bar and, particularly to a pry bar having improved structural strength and a greater support area.

2. Description of the Related Art

TW Patent No. M310,787 shows a pry bar including a hollow body and two operation ends respectively disposed on two ends of the hollow body. One of the operation ends and the hollow body cooperate to form an L shaped structure, and this operation end has a cutout for receiving a nail to be pried. A fulcrum of the pry bar is defined at a corner edge of the L shaped structure, and the hollow body can be used as a lever arm. It is noted that, upon using the pry bar to pry the nail out of the plate, the pry bar has a relative small area in contact with the plate. Unfortunately, the plate is under a relative large pressure and is liable to get damaged and can not be reused.

The present invention is, therefore, intended to obviate or at least alleviate the problems encountered in the prior art.

### SUMMARY OF THE INVENTION

According to the present invention, a pry bar includes a body and a claw disposed at a first end of the body. The claw includes rib and wing structures. The rib and wing structures are both extended away from the body in a first direction. The rib and wing structures are disposed at front and back sides of the claw respectively, with the front side opposite the back side. The rib and wing structures each have a width extended in a second direction transverse to the first direction, with the width of the rib structure different from that of the wing structure. The rib structure reinforces structural strength of the claw and the wing structure provides the claw with a greater support area to contact with a surface with which an objected to be pried is engaged.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a pry bar having a greater support area.

It is also an object of the present invention to provide a pry bar having improved structural strength.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a pry bar having improved structural strength and a greater support area in accordance with the present invention.

FIG. 2 is an exploded perspective view of the pry bar of FIG. 1.

FIG. 3 is a cross-sectional view of the pry bar of FIG. 1.

FIG. 4 is a cross-sectional view taken along 4-4 of FIG. 1.

FIG. 5 is a cross-sectional view taken along line 5-5 of FIG. 4.

FIG. 6 is a cross-sectional view taken along line 6-6 of FIG. 4.

FIG. 7 is a top view of a support area from an operation end of the pry bar of FIG. 1.

FIG. 8 is a cross-sectional view of another operating end of the pry bar of FIG. 1.

FIG. 9 is a cross-sectional view illustrating the pry bar of FIG. 1 in operation to pry a nail.

FIG. 10 is a continued cross-sectional view of FIG. 9.

### DETAILED DESCRIPTION OF THE INVENTION

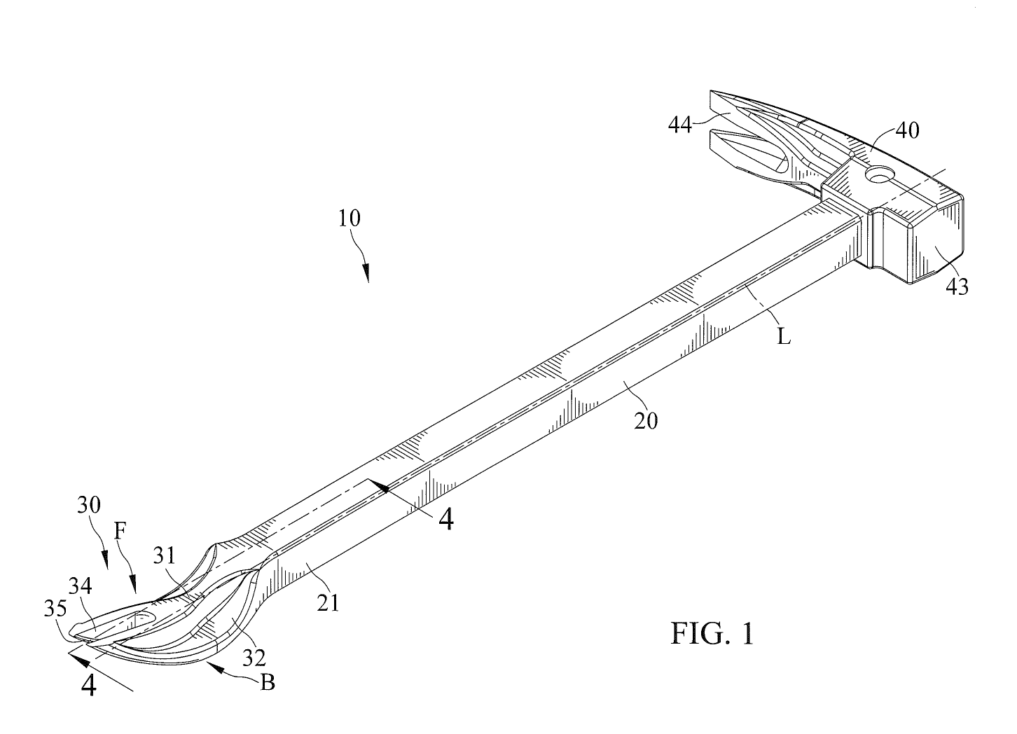

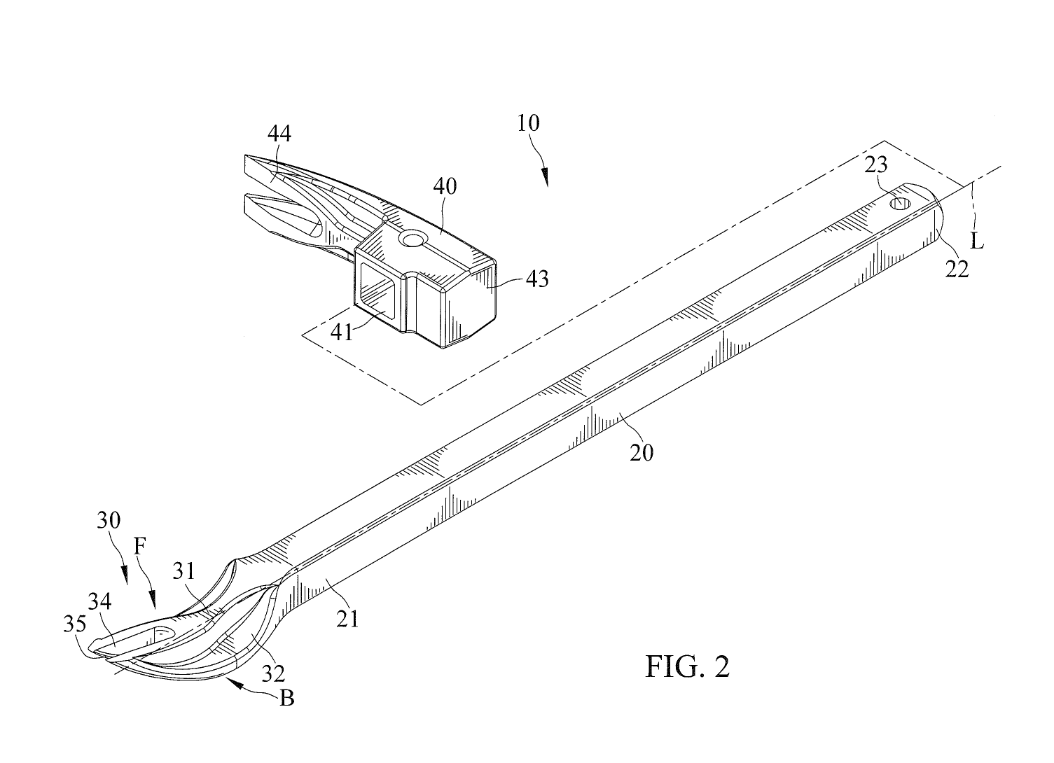

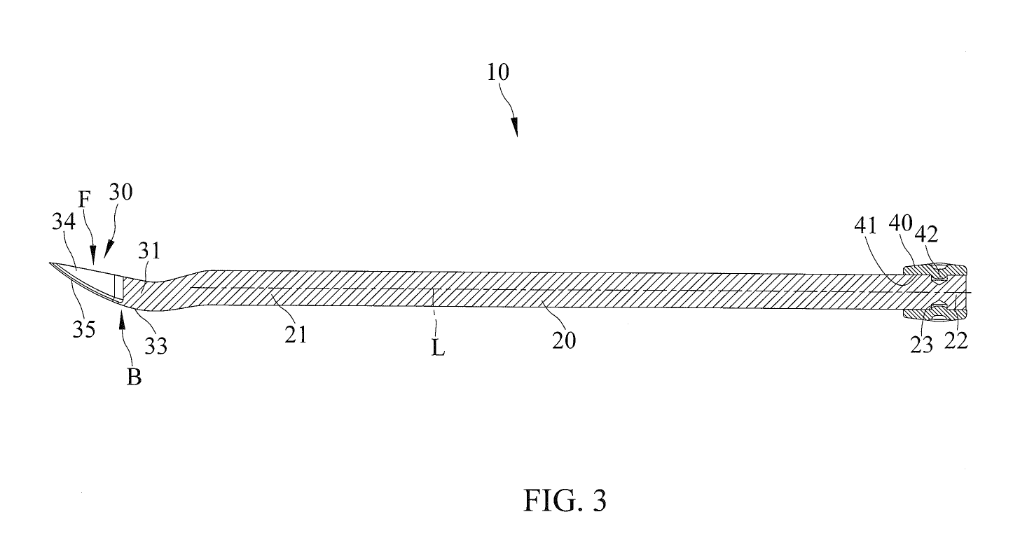

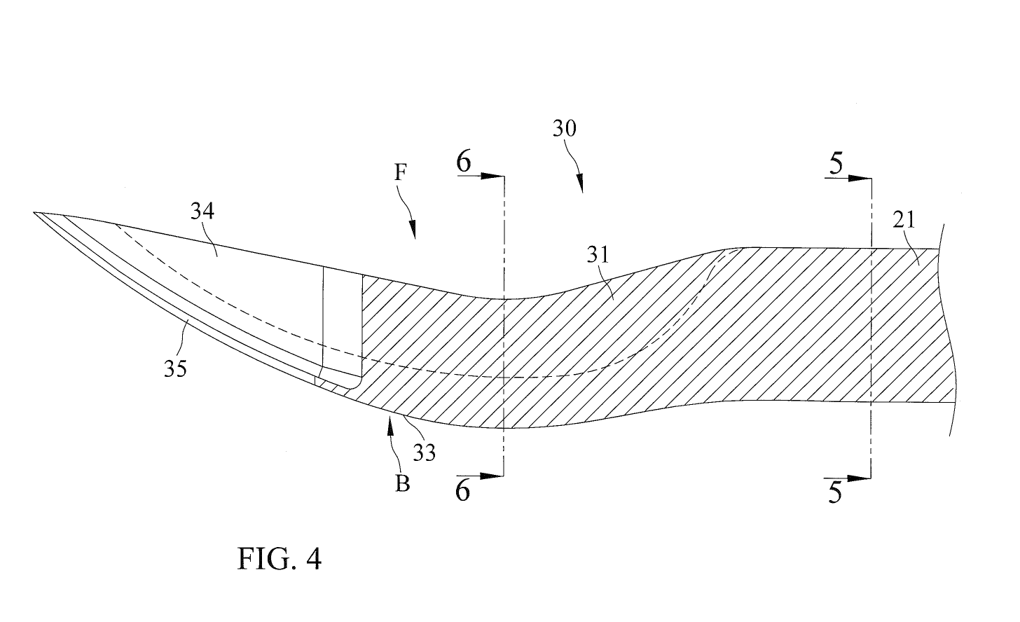

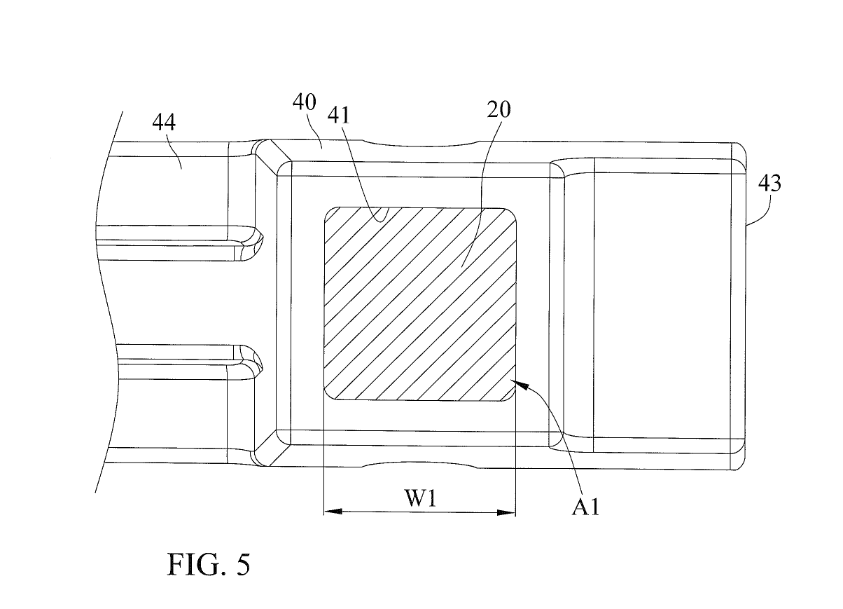

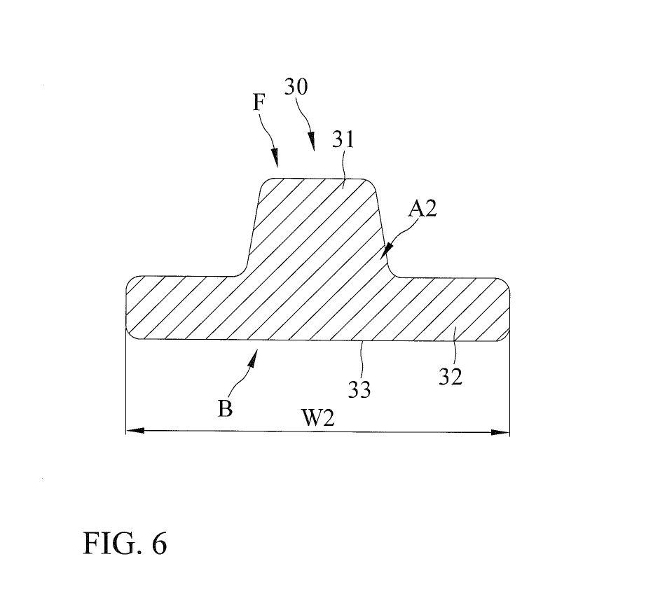

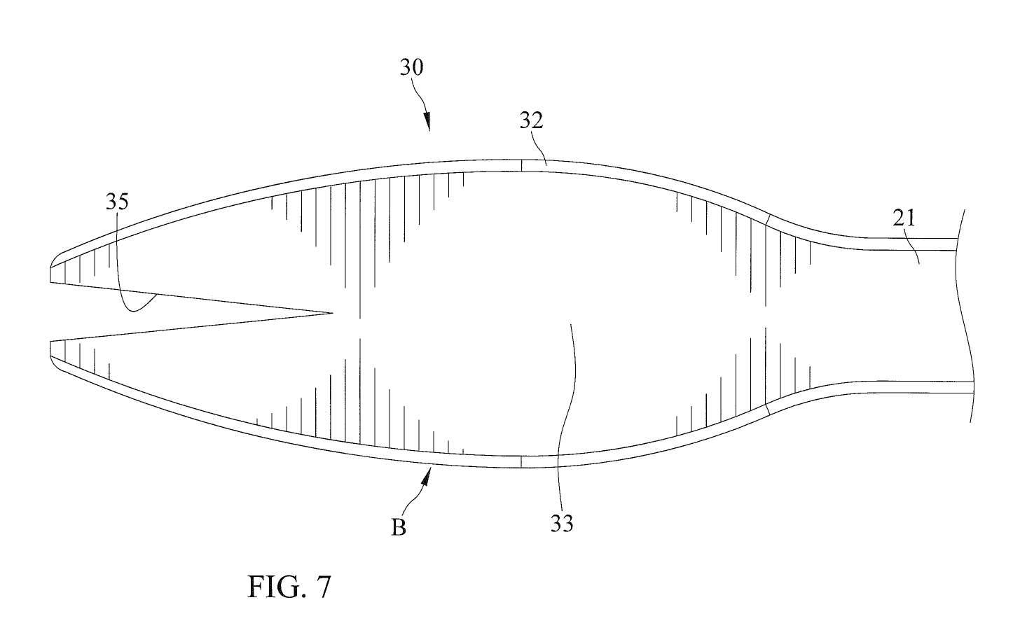

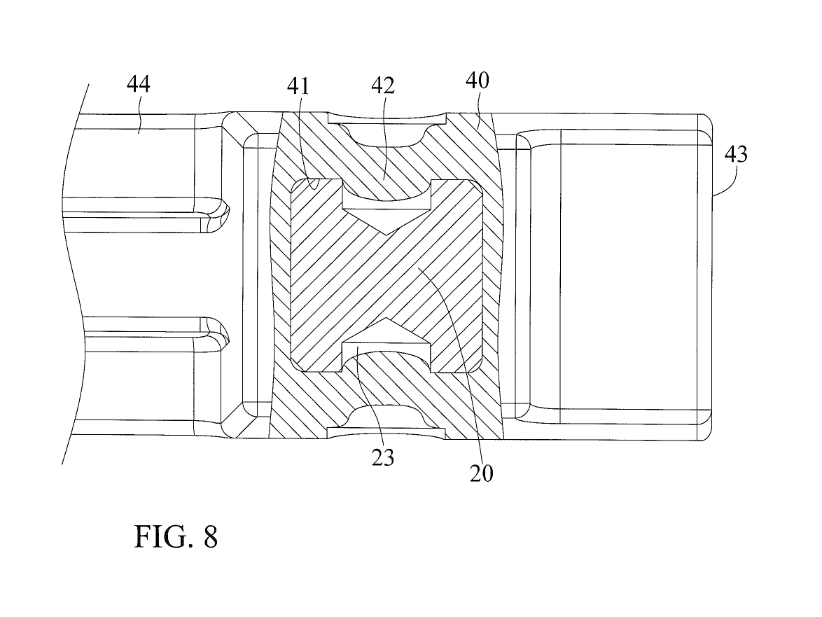

FIGS. 1 through 10 show a pry bar 10 having improved structural strength and a greater support area in accordance with the present invention. The pry bar 10 includes a body 20 and a claw 30.

The body 20 has a first end 21 and a second end 22 opposite the first end 21. The first and second ends 21 and 22 are defined at two distal ends of the body 20, respectively. The body 20 is in the form of an elongated rod and is extended longitudinally along an axis L. The body 20 has a first cross-sectional area A1 perpendicular to the axis L and having a first width W1.

The claw 30 is disposed at the first end 21 of the body 20. The claw 30 and the body 20 can be forged as a one-piece structure, but not limiting. The claw 30 includes rib and wing structures 31 and 32. The rib structure 31 reinforces structural strength of the claw 30 and the wing structure 32 provides the claw 30 with a greater support area to contact with a surface with which an objected to be pried is engaged. The rib and wing structures 31 and 32 are both extended away from the body 20 in a first direction. The rib and wing structures 31 and 32 are disposed at front and back sides F and B of the claw 30 respectively. The front side F is opposite the back side B. The rib and wing structures 31 and 32 each have a width extended in a second direction transverse to the first direction, with the width of the rib structure 31 different from that of the wing structure 32. The width of the wing structure 32 is greater than that of the rib structure 31. The rib structure 31 is extended along a middle of the wing structure 32 in the first direction. The wing structure 32 has one extension disposed on the right and left of the rib structure 31, and the extensions have substantially the same width. The claw 30 has a T shaped cross section.

The wing structure 32 includes two opposite sides in which one side includes the rib structure 31 extended therefrom and the other side defines a support surface 33 which is extended curvedly. The body 20 includes a side adjacent to the support surface 33 and the support surface 30 has an extent at a lower level than the side. The claw 30 includes a recess 34 for receiving the object to be pried, and the recess 34 is extended from the rib structure 31 to the wing structure 32. The recess 34 delimits an opening and includes a peripheral wall including a flange 35 protruded therefrom and disposed in the opening. The recess 34 is V-shaped, but not limiting. Since the recess 34 is V shaped, it includes two opposite sides which have a common edge and are extended separately from the common edge.

The claw 30 has a second cross-sectional area A2 perpendicular to the axis L and having a second width W2. The second cross-sectional area A2 is not smaller than the first cross-sectional area A1. The second width W2 is greater than the first width W1.

In the embodiment, the pry bar 10 also includes a tool head 40 extended from the body 20 for driving an object. The tool head 40 is disposed at the second end 22 of the body 20. The tool head 40 can be fixedly or slidably engaged with the body 20. The tool head 40 includes a cavity 41, and the body 20 is engaged with the tool head 40 by including the second end 22 fitted in the cavity 41. The tool head 40 has a first end forming an anvil 43 and a second end forming a claw 44. The claw 44 of the tool head 40 and the claw 30 disposed on the first end 21 of the body 20 have the same structure.

One of the body 20 and the tool head 40 includes at least one notch 23 and the other of the body 20 and the tool head 40 includes at least one hook 42 respectively, and the at least one hook 42 is engaged in the at least one notch to prevent disengagement of the body 20 with the tool head 40. Here, two notches 23 are inset into an outer periphery of the body 20 and disposed adjacent to the second end 22 thereof, and two hooks 42 are extended from a wall delimiting the cavity 41.

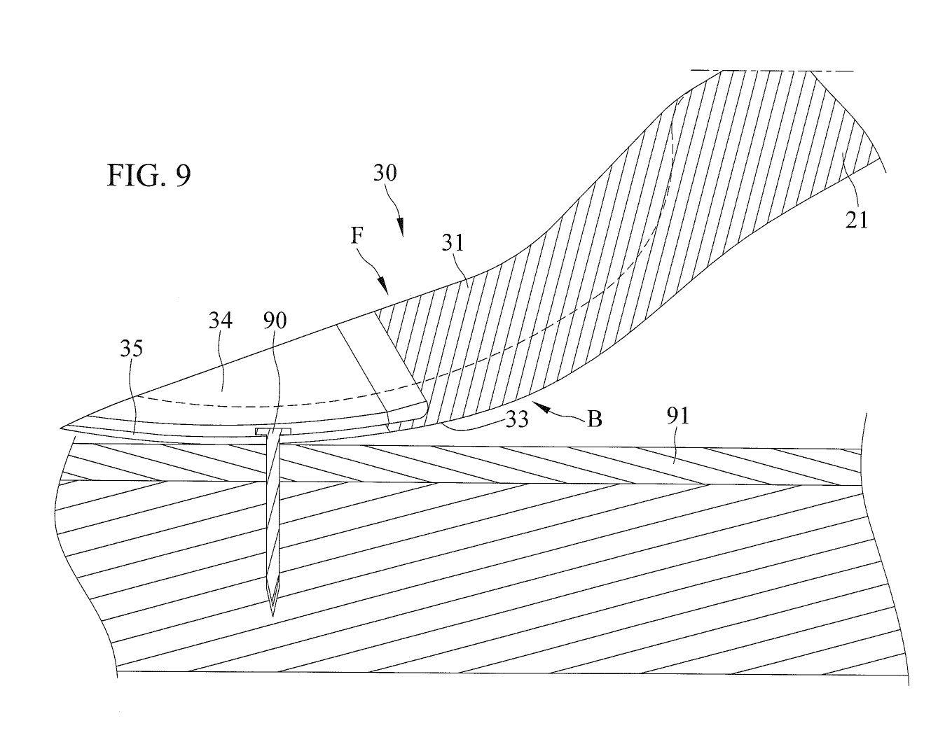

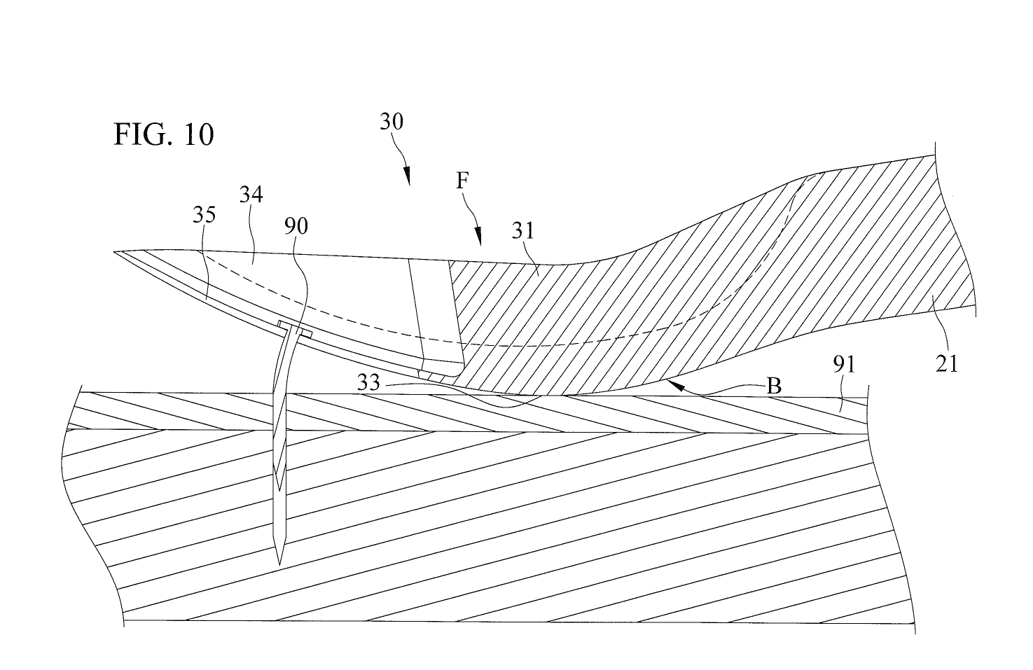

FIGS. 9 and 10 show the pry bar 10 in operation to pry a nail 90 out of a plate 91. The pry bar 10 is supported on the plate 91 by including the support surface 33 abutting against the plate 91. Additionally, since the support surface 33 is extended curvedly and has an extent at a lower level than the body 20, the pry bar 10 is angled with respect to the plate 91 in a manner that allows a user to gain a better operation space.

In view of the forgoing, there is provided a pry bar 10 having improved structural strength and a greater support area in that the rib structure 31 reinforces structural strength of the claw 30 and the wing structure 32 provides the claw 30 with a greater support area to contact with a surface with which an objected to be pried is engaged.

While the specific embodiments have been illustrated and described, numerous modifications come to mind without significantly departing from the spirit of invention, and the scope of invention is only limited by the scope of accompanying claims.

What is claimed is:

1. A pry bar having improved structural strength and a greater support area comprising:
a body; and
a claw disposed at a first end of the body and including rib and wing structures, with the rib and wing structures both extended away from the body in a first direction, with the rib and wing structures disposed at front and back sides of the claw respectively, with the front side opposite the back side, with the rib and wing structures each having a width extended in a second direction transverse to the first direction, with the width of the rib structure different from that of the wing structure, and wherein the rib structure reinforces structural strength of the claw and the wing structure provides the claw with a greater support area to contact with a surface with which an objected to be pried is engaged.

2. The pry bar having improved structural strength and a greater support area as claimed in claim 1, wherein the body is extended longitudinally along an axis and has a first cross-sectional area perpendicular to the axis and having a first width, and the claw has a second cross-sectional area perpendicular to the axis and having a second width, wherein the second cross-sectional area is not smaller than the first cross-sectional area.

3. The pry bar having improved structural strength and a greater support area as claimed in claim 2, wherein the second width is greater than the first width.

4. The pry bar having improved structural strength and a greater support area as claimed in claim 1, wherein the claw and the body are forged as a one-piece structure.

5. The pry bar having improved structural strength and a greater support area as claimed in claim 1, wherein the rib structure is extended along a middle of the wing structure in the first direction.

6. The pry bar having improved structural strength and a greater support area as claimed in claim 5, wherein the claw has a T shaped cross section.

7. The pry bar having improved structural strength and a greater support area as claimed in claim 1, wherein the wing structure includes two opposite sides in which one side includes the rib structure extended therefrom and the other side defines a support surface which is extended curvedly.

8. The pry bar having improved structural strength and a greater support area as claimed in claim 7, wherein the body includes a side adjacent to the support surface, and the support surface has an extent at a lower level than the side.

9. The pry bar having improved structural strength and a greater support area as claimed in claim 1, wherein the claw includes a recess for receiving the object to be pried, and the recess is extended from the rib structure to the wing structure.

10. The pry bar having improved structural strength and a greater support area as claimed in claim 9, wherein the recess delimits an opening and includes a peripheral wall including a flange protruded therefrom and disposed in the opening.

11. The pry bar having improved structural strength and a greater support area as claimed in claim 1 further comprising a tool head extended from the body for driving an object.

12. The pry bar having improved structural strength and a greater support area as claimed in claim 11, wherein the tool head has a first end forming an anvil and a second end forming a claw.

13. The pry bar having improved structural strength and a greater support area as claimed in claim 12, wherein the claw of the tool head and the claw disposed on the first end of the body have the same structure.

14. The pry bar having improved structural strength and a greater support area as claimed in claim 13, wherein the tool head includes a cavity, and the body is engaged with the tool head by including an end fitted in the cavity.

15. The pry bar having improved structural strength and a greater support area as claimed in claim 14, wherein one of the body and the tool head includes at least one notch and the other of the body and the tool head includes at least one hook respectively, and the hook is engaged in the notch to prevent disengagement of the body with the tool head.

16. The pry bar having improved structural strength and a greater support area as claimed in claim 1, wherein the width of the wing structure is greater than that of the rib structure.

17. The pry bar having improved structural strength and a greater support area as claimed in claim 16, wherein the body is extended longitudinally along an axis and has a first cross-sectional area perpendicular to the axis and having a first width, and the claw has a second cross-sectional area perpendicular to the axis and having a second width, wherein the second cross-sectional area is not smaller than the first cross-sectional area.

18. The pry bar having improved structural strength and a greater support area as claimed in claim 17, wherein the second width is greater than the first width.

19. The pry bar having improved structural strength and a greater support area as claimed in claim 16, wherein the claw includes a recess for receiving the object to be pried, and the recess is extended from the rib structure to the wing structure.

20. The pry bar having improved structural strength and a greater support area as claimed in claim 16 further comprising a tool head extended from the body for driving an object.
